(19) United States
(12) Patent Application Publication
(10) Pub. No.: US 2025/0370607 A1
(43) Pub. Date: Dec. 4, 2025

(54) METHOD AND APPARATUS FOR EFFECT EDITING, DEVICE AND STORAGE MEDIUM

(71) Applicant: Lemon Inc., Grand Cayman (KY)

(72) Inventors: Hai Quang Kim, Los Angeles, CA (US); Runjia Tian, Los Angeles, CA (US)

(21) Appl. No.: 19/221,268

(22) Filed: May 28, 2025

(30) Foreign Application Priority Data
May 29, 2024 (CN) 202410683539.5

(51) Int. Cl. G06F 3/04845; G06F 3/0481; G06F 9/451

(52) U.S. Cl. CPC G06F 3/04845; G06F 3/0481; G06F 9/451

(57) ABSTRACT

The present disclosure relates to a method and an apparatus for effect editing, a device and a computer-readable storage medium. The method provided by the present disclosure includes: in response to receiving a preset operation, presenting a command line component in an effect editing interface; obtaining a target command line through the command line component; parsing the target command line into a first group of commands to be executed based on a group of preset commands associated with the effect editing interface; and executing the first group of commands in the effect editing interface by invoking a first group of application program interfaces corresponding to the first group of commands. In this way, embodiments of the present disclosure can support calling a corresponding application program interface through a command line manner in an effect editing scene to complete a corresponding effect editing operation, thereby improving efficiency of effect editing.

### CROSS-REFERENCE

This application claims the priority to Chinese Patent Application No. 202410683539.5, entitled “METHOD AND APPARATUS FOR EFFECT EDITING, DEVICE AND STORAGE MEDIUM” filed on May 29, 2024, the entire contents of which are incorporated herein by reference.

### FIELD

Example embodiments of the present disclosure generally relate to the field of computers, and in particular, to a method and an apparatus for effect editing, a device and a computer-readable storage medium.

### BACKGROUND

With the development of computer technologies, the Internet has become an important platform for authoring and sharing media content. In the creation process of media content, a video effect and a picture effect are creation means frequently used by a user in an authoring process. The effect can enrich media content authored by a user and improve the interestingness of the content.

### SUMMARY

In a first aspect of the present disclosure, a method for effect editing is provided. The method comprises: in response to receiving a preset operation, presenting a command line component in an effect editing interface; obtaining a target command line through the command line component; parsing the target command line into a first group of commands to be executed based on a group of preset commands associated with the effect editing interface; and executing the first group of commands in the effect editing interface by invoking a first group of application program interfaces corresponding to the first group of commands.

In a second aspect of the present disclosure, an apparatus for effect editing is provided. The apparatus comprises a presentation module, configured to in response to receiving a preset operation, present a command line component in an effect editing interface; an obtaining module, configured to obtain a target command line through the command line component; a parsing module, configured to parse the target command line into a first group of commands to be executed based on a group of preset commands associated with the effect editing interface; and an execution module, configured to execute the first group of commands in the effect editing interface by invoking a first group of application program interfaces corresponding to the first group of commands.

In a third aspect of the present disclosure, an electronic device is provided. The device comprises at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2A illustrates an example editing interface according to some embodiments of the present disclosure;

FIG. 2B illustrates an example command line according to some embodiments of the present disclosure;

FIG. 3 illustrates an example editing system according to some embodiments of the present disclosure;

FIG. 4 illustrates a flowchart of an example process of effect editing according to some embodiments of the present disclosure;

FIG. 5 illustrates a schematic structural block diagram of an example apparatus for effect editing according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legal basis (for example, obtaining consent of a personal information subject, or necessary for performing a fulfillment contract), and processing only within a specified or agreed range. The user rejects personal information other than necessary information required by the basic function, and does not affect the basic function of the user.

As mentioned above, in the authoring process of media content, video effects and picture effects are authoring means that users often use during authoring. The effect can enrich media content authored by a user and improve the fun degree of the content.

Some conventional schemes may support a user performing a particular editing operation through a graphical user interface, however such an interaction is inefficient for some complex editing scenarios.

The embodiment of the present disclosure provides an effect editing scheme. According to the solution, the command line component may be presented in the effect editing interface in response to receiving the preset operation. Further, the target command line may be obtained through a command line component. Additionally, the target command line may be parsed into the first group of commands to be executed based on a set of preset commands associated with the effect editing interface. Correspondingly, the first group of commands may be executed in the effect editing interface by invoking the first group of application program interfaces corresponding to the first group of commands.

In this way, embodiments of the present disclosure can support calling a corresponding application program interface through a command line manner in an effect editing scene to complete a corresponding effect editing operation, thereby improving efficiency of effect editing.

Various example implementations of this scheme are described in detail below in conjunction with the accompanying drawings.

### Example Environment

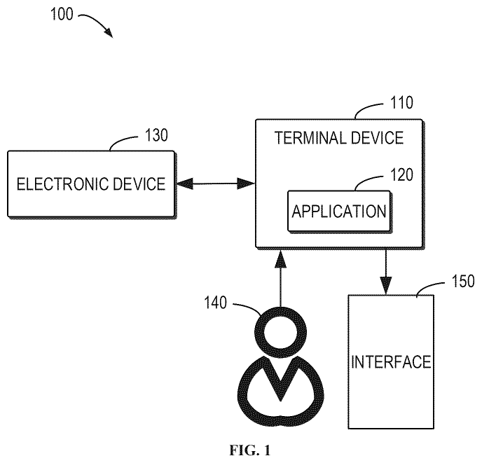

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to: effect editing applications. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

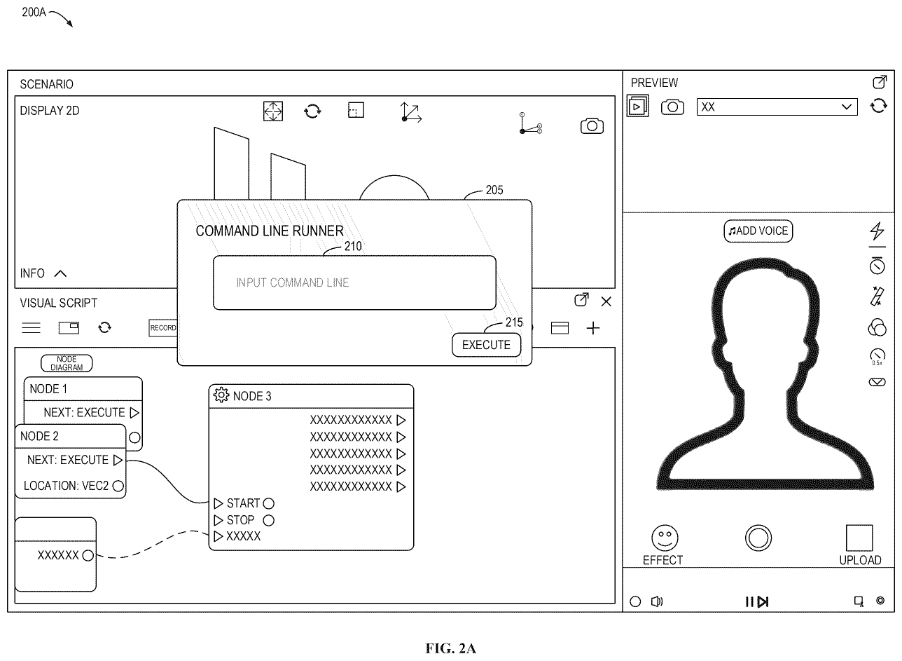

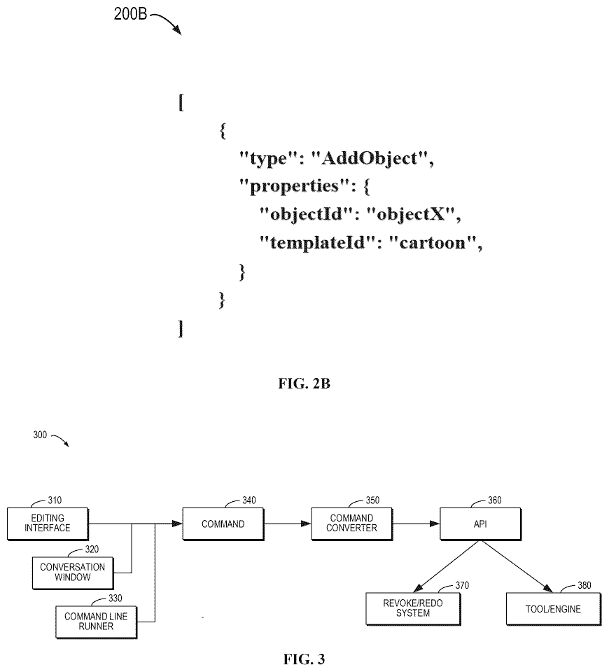

FIG. 2A illustrates an example editing interface 200A, in accordance with some embodiments of the present disclosure. The editing interface 200A may be provided, for example, by the electronic device 110 shown in FIG. 1. As an example, the interface 200A may be an editing interface for editing an effect.

As shown in FIG. 2A, the electronic device 110 may receive a preset request to open a command line runner 205 (also referred to as a command line component), and accordingly present a command line running period in the editing interface 200A.

As shown in FIG. 2A, the command line runner 205 may include an input control 210 to support user input of command line content. As an example, the electronic device 110 may, for example, receive a command line typed by a user in the input control 210. Alternatively, the electronic device 110 may also support the user to copy the edited command line into the input control 210, for example.

In yet other embodiments, the electronic device 110 may further obtain the command line file uploaded or imported by the user via the command line runner 205, so as to determine the command line content to be executed.

FIG. 2B illustrates an example command line 200B according to some embodiments of the present disclosure. As shown in FIG. 2B, such command line 200B may be written, for example, by way of structured text.

In some embodiments, such command line 200B may indicate an identification of an editing command to be executed. Taking FIG. 2B as an example, the command line 200B may indicate that the identifier of the editing command to be executed is “AddObject”. The identification may, for example, correspond to an editing command for adding an object in the editing interface 200A.

Additionally, the command line 200B may also indicate at least one execution parameter associated with the editing command to be executed. For example, “objectId” and “templateId” may indicate an identifier of an object to be added and an object template used by an object to be added, respectively.

It should be understood that the content of the specific command line shown in FIG. 2B is merely an example, and is not intended to constitute a limitation on the present disclosure.

As an example, the electronic device 110 may, for example, receive the command line 200B entered by the user via the command line running period 205, and may trigger the execution of the corresponding editing command accordingly.

An example editing system 300 according to some embodiments of the present disclosure will be further described below with reference to FIG. 3. As shown in FIG. 3, the editing system 300 may convert the command line obtained via the command line executor 330 into the command 340 to be executed.

In some embodiments, to provide the flexibility of the editing system, the editing system 300 may, for example, parse the received command line into a first group of commands to be executed based on a set of preset commands associated with the effect editing interface 200A.

In some embodiments, such a set of preset commands may be determined based on a set of application program interface APIs associated with the effects editing interface 200A. For example, the editing system 300 may generate a corresponding set of preset commands based on a set of business APIs associated with the effects editing interface 200A. For example, the editing system 300 may determine the command to be executed as an “add object” command from a set of preset commands based on the command identifier indicated in the command line 200B. In some embodiments, the command line input by the user may also correspond to a plurality of commands to be executed.

With continued reference to FIG. 3, the editing system 300 may also include a command converter 350. The command translator 350 may convert the first set of commands to be executed into a corresponding first set of APIs, e.g., API 360. Specifically, the command converter 350 may, for example, maintain a mapping relationship between the set of preset commands and the set of preset APIs, and may convert the first group of commands into the first group of APIs based on the mapping relationship.

Further, the editing system 300 may execute the corresponding first group of commands by invoking the determined first group of APIs. Taking the command shown in FIG. 2B as an example, the editing system 300 may invoke the corresponding tool or engine 380 through the API 360 to perform the corresponding editing operation, thereby triggering the addition of the defined object “objectX” in the editing interface 200A.

In some embodiments, the API 360 may correspond to, for example, an API internal to the application 120 running locally on the electronic device 110, or may correspond to a remote API provided by a remote device (e.g., the server 130). In this way, embodiments of the present disclosure may further provide flexibility of the editing system.

In this way, the embodiments of the present disclosure can support calling a corresponding application program interface through a command line manner in an effect editing scene to complete a corresponding effect editing operation, thereby improving efficiency of effect editing.

With continued reference to FIG. 3, the editing system 300 may also, for example, also edit user operations received in the interface 310 based on a unified architecture. Specifically, the editing system 300 may, for example, acquire an interactive operation of the user for the interface element via the editing interface 310 (for example, the editing interface 200A shown in FIG. 2A), for example, any suitable operations such as a click on a button, a drag on an object, and the like.

Further, the editing system 300 may convert the received interaction operation into a second group of commands to be executed, such as the command 340. Specifically, the editing system 300 may convert the received interaction operation into the to-be-executed instruction, for example, based on a mapping relationship between various interaction operations supported by the editing interface 310 and a group of preset commands.

Further, based on the similar processes described above, the editing system 300 may determine the second group of APIs corresponding to the second group of commands based on the unified command execution architecture, and may trigger the execution of the corresponding editing operation by calling the second group of APIs.

With continued reference to FIG. 3, the editing system 300 may also provide a conversation window 320 for the user, to support triggering a corresponding editing operation in a conversation manner. In some embodiments, such conversation window 320 may, for example, support conversational interactions between a user and a virtual object. Such a virtual object may, for example, be associated with a corresponding virtual entity, such as an appropriate machine learning model.

In some embodiments, the editing system 300 may convert the target message received in the conversation window into a third group of commands to be executed, such as the command 340. Specifically, the target message may include, for example, a message entered by the user via the conversation window, or may include a reply message generated by the virtual entity based on the user input message.

Further, the editing system 300 may convert the target message into a third group of commands to be executed based on the associated set of preset commands. Further, based on the similar processes described above, the editing system 300 may determine the third group of APIs corresponding to the third group of commands based on the unified command execution architecture, and may trigger the execution of the corresponding editing operation by calling the third group of APIs.

In this manner, embodiments of the present disclosure may respond to editing requests initiated by a user in different scenarios based on a unified command processing architecture, for example, an editing request initiated via a command line component 330, an editing request initiated via an editing interface 310, or an editing request initiated via a dialog window 320 or the like. Therefore, the embodiment of the present disclosure can improve the uniformity of the architecture of the editing system, and can improve the expandability of the system so as to support unified processing of the editing request initiated by other more modes.

In some embodiments, execution of API 360 may also be associated with revoke/redo system 370. In this manner, the editing system 300 may support revoke or redo by the execution process of the API 360 called above. Taking the execution of the API 360 triggered by the command line executor 330 as an example, after the command line received via the command line executor 205 is triggered to execute, the electronic device 110 may receive a revocation request via the editing interface 200A. Further, the editing system 300 may revoke the execution of at least some of the first group of commands corresponding to the command line by the revoke/redo system 370.

Taking FIG. 2B as an example, after receiving the revocation request, the electronic device 110 may cancel the addition of the object “objectX”. Further, after receiving the redo request, the electronic device 110 may, for example, restore the addition of the object “objectX”.

In some embodiments, where the command line corresponds to multiple commands, the electronic device 110 may, for example, revoke the execution of all commands based on the received revocation request. Alternatively, the electronic device 110 may, for example, also cancel the execution of the last command or the last associated plurality of commands based on the received revocation request.

In this way, embodiments of the present disclosure can further improve the efficiency of the effect editing and improve the reliability of the editing system.

### Example Processes

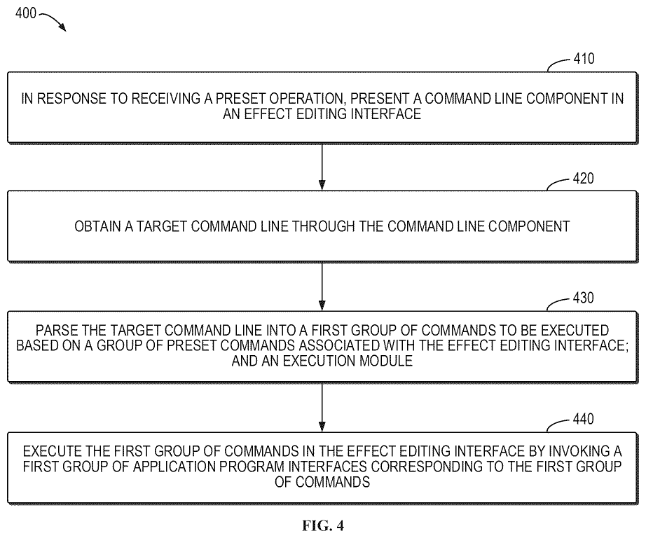

FIG. 4 illustrates a flowchart of an example process 400 of editing an effect according to some embodiments of the present disclosure. Process 400 may be implemented at electronic device 110. The process 400 is described below with reference to FIG. 1.

As shown, in block 410, the electronic device 110 presents the command line component in the effect editing interface in response to receiving the preset operation.

At block 420, the electronic device 110 obtains the target command line via a command line component.

At block 430, the electronic device 110 parses the target command line into a first group of commands to be executed based on a set of preset commands associated with the effect editing interface.

At block 440, the electronic device 110 executes the first set of commands in the effect editing interface by invoking a first set of application program interfaces corresponding to the first set of commands.

In some embodiments, the process 400 further comprises: receiving an interaction operation for an interface element in the effect editing interface; converting the interaction operation into a second group of commands to be executed based on a group of preset commands associated with the effect editing interface; and executing the second group of commands in the effect editing interface by invoking a second group of application program interfaces corresponding to the second group of commands.

In some embodiments, the process 400 further comprises: presenting a conversation window associated with the effect editing interface, the conversation window being associated with the virtual object; in response to receiving the target message in the conversation window, converting the target message into a third group of commands to be executed based on a group of preset commands associated with the effect editing interface; and executing the third group of commands in the effect editing interface by invoking a third group of application program interfaces corresponding to the third group of commands.

In some embodiments, the process 400 further comprises providing description information about a set of preset commands to a processing entity associated with the virtual object.

In some embodiments, the process 400 further comprises: in response to receiving the revocation request, revoking at least some of the first group of commands in the effect editing interface.

In some embodiments, the target command line indicates at least one of the following: an identifier of an editing instruction to be executed; and at least one execution parameter associated with the to-be-executed editing instruction.

In some embodiments, the obtaining the target command line via the command line component comprises: obtaining the target command line input via the input control of the command line component; or importing the command line file via the command line component to obtain the target command line.

In some embodiments, the process 400 further comprises: obtaining mapping information, where the mapping information indicates a mapping relationship between a group of preset commands and a group of preset application program interfaces; and determining, based on the mapping information, a first group of application program interfaces corresponding to the first group of commands.

### Example Apparatus and Apparatus

Embodiments of the present disclosure also provide a corresponding apparatus for implementing the above method or process. FIG. 5 illustrates a schematic structural block diagram of an example apparatus 500 for editing an effect according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes a presentation module 510 configured to present a command line component in an effect editing interface in response to receiving a preset operation; an acquiring module 520 configured to acquire a target command line via a command line component; a parsing module 530 configured to parse the target command line into a first group of commands to be executed based on a group of preset commands associated with the effect editing interface; and an executing module 540 configured to execute the first group of commands in the effect editing interface by invoking a first group of application program interfaces corresponding to the first group of commands.

In some embodiments, the apparatus 500 further comprises an operation processing module configured to: receive an interaction operation for an interface element in the effect editing interface; convert the interaction operation into a second group of commands to be executed based on a group of preset commands associated with the effect editing interface; and execute the second group of commands in the effect editing interface by invoking a second group of application program interfaces corresponding to the second group of commands.

In some embodiments, the apparatus 500 further comprises a session processing module configured to: present a conversation window associated with the effect editing interface, the conversation window being associated with the virtual object; in response to receiving the target message in the conversation window, convert the target message into a third group of commands to be executed based on a group of preset commands associated with the effect editing interface; and execute the third group of commands in the effect editing interface by invoking a third group of application program interfaces corresponding to the third group of commands.

In some embodiments, the apparatus 500 further comprises a provision module configured to provide description information about a set of preset commands to a processing entity associated with the virtual object.

In some embodiments, the apparatus 500 further comprises a revocation module configured to, in response to receiving the revocation request, revoke at least some of the first group of commands in the effect editing interface.

In some embodiments, the target command line indicates at least one of the following: an identifier of an editing instruction to be executed; and at least one execution parameter associated with the to-be-executed editing instruction.

In some embodiments, the obtaining module 520 is further configured to: obtain the input target command line via the input control of the command line component; or import the command line file via the command line component to obtain the target command line.

In some embodiments, the apparatus 500 further comprises a conversion module configured to: obtain mapping information, where the mapping information indicates a mapping relationship between a group of preset commands and a group of preset application program interfaces; and determine, based on the mapping information, a first group of application program interfaces corresponding to the first group of commands.

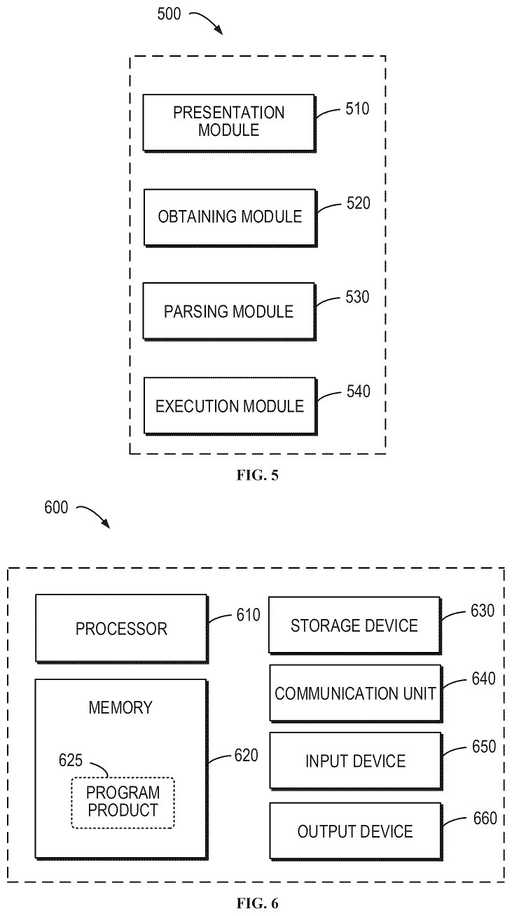

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may be configured to implement the electronic device 110 in FIG. 1.

As shown in FIG. 6, the electronic device 600 is in the form of a general-purpose electronic device. Components of the electronic device 600 may include, but are not limited to, one or more processors or processors 610, a memory 620, a storage device 630, one or more communication units 640, one or more input devices 650, and one or more output devices 660. The processor 610 may be an actual or virtual processor and capable of performing various processes according to programs stored in the memory 620. In multiprocessor systems, multiple processors execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for effect editing comprising:
in response to receiving a preset operation, presenting a command line component in an effect editing interface;
obtaining a target command line through the command line component;
parsing the target command line into a first group of commands to be executed based on a group of preset commands associated with the effect editing interface; and
executing the first group of commands in the effect editing interface by invoking a first group of application program interfaces corresponding to the first group of commands.

2. The method of claim 1, further comprising:
receiving an interaction operation for an interface element in the effect editing interface;
converting the interaction operation into a second group of commands to be executed based on the group of preset commands associated with the effect editing interface; and
executing the second group of commands in the effect editing interface by invoking a second group of application program interfaces corresponding to the second group of commands.

3. The method of claim 1, further comprising:
presenting a conversation window associated with the effect editing interface, the conversation window being associated with a virtual object;
in response to receiving a target message in the conversation window, converting the target message into a third group of commands to be executed based on the group of preset commands associated with the effect editing interface; and
executing the third group of commands in the effect editing interface by invoking a third group of application program interfaces corresponding to the third group of commands.

4. The method of claim 3, further comprising:
providing description information about the set of preset commands to a processing entity associated with the virtual object.

5. The method of claim 1, further comprising:
in response to receiving the revocation request, revoking an execution of at least part of the commands in the first group of commands in the effect editing interface.

6. The method of claim 1, wherein the target command line indicates at least one of the following:
an identifier of an editing instruction to be executed;
at least one execution parameter associated with the editing instruction to be executed.

7. The method of claim 1, wherein obtaining the target command line via the command line component comprises:
obtaining the target command line input via an input control of the command line component; or
importing a command line file through the command line component to obtain the target command line.

8. The method of claim 1, further comprising:
obtaining mapping information, the mapping information indicating a mapping relationship between the set of preset commands and a set of preset application program interfaces; and
determining the first group of application program interfaces corresponding to the first group of commands based on the mapping information.

9. An electronic device, comprising:
at least one processor; and
a memory configured to store at least one program;
the at least one program, when executed by the at least one processor, cause the at least one processor to perform a method comprising:
obtaining a target command line through the command line component;
parsing the target command line into a first group of commands to be executed based on a group of preset commands associated with the effect editing interface; and
executing the first group of commands in the effect editing interface by invoking a first group of application program interfaces corresponding to the first group of commands.

10. The device of claim 9, further comprising:
receiving an interaction operation for an interface element in the effect editing interface;
converting the interaction operation into a second group of commands to be executed based on the group of preset commands associated with the effect editing interface; and
executing the second group of commands in the effect editing interface by invoking a second group of application program interfaces corresponding to the second group of commands.

11. The device of claim 9, further comprising:
presenting a conversation window associated with the effect editing interface, the conversation window being associated with a virtual object;
in response to receiving a target message in the conversation window, converting the target message into a third group of commands to be executed based on the group of preset commands associated with the effect editing interface; and
executing the third group of commands in the effect editing interface by invoking a third group of application program interfaces corresponding to the third group of commands.

12. The device of claim 11, further comprising:
providing description information about the set of preset commands to a processing entity associated with the virtual object.

13. The device of claim 9, further comprising:
in response to receiving the revocation request, revoking an execution of at least part of the commands in the first group of commands in the effect editing interface.

14. The device of claim 9, wherein the target command line indicates at least one of the following:
an identifier of an editing instruction to be executed;
at least one execution parameter associated with the editing instruction to be executed.

15. The device of claim 9, wherein obtaining the target command line via the command line component comprises:
obtaining the target command line input via an input control of the command line component; or
importing a command line file through the command line component to obtain the target command line.

16. The device of claim 9, further comprising:
obtaining mapping information, the mapping information indicating a mapping relationship between the set of preset commands and a set of preset application program interfaces; and
determining the first group of application program interfaces corresponding to the first group of commands based on the mapping information.

17. A non-transitory computer-readable storage medium having stored thereon a computer program, wherein the computer program, when executed by a processor, implements a method comprising:
obtaining a target command line through the command line component;
parsing the target command line into a first group of commands to be executed based on a group of preset commands associated with the effect editing interface; and
executing the first group of commands in the effect editing interface by invoking a first group of application program interfaces corresponding to the first group of commands.
